(19) United States
(12) Patent Application Publication
(10) Pub. No.: US 2024/0067237 A1
(43) Pub. Date: Feb. 29, 2024

(54) TRAIN HAVING PROTECTION DEVICE WITH SELF-ADAPTIVE CRASHWORTHINESS

(71) Applicant: Central South University, Changsha City (CN)

(72) Inventors: Jian LI, Changsha City (CN); Guangjun GAO, Changsha City (CN); Zihao XIE, Changsha City (CN); Yao Yu, Changsha City (CN); Jialin LI, Changsha City (CN)

(73) Assignee: Central South University, Changsha City (CN)

(21) Appl. No.: 18/052,301

(22) Filed: Nov. 3, 2022

(30) Foreign Application Priority Data
Aug. 29, 2022 (CN) 202211036730.8

(51) Int. Cl. B61D 15/06

(52) U.S. Cl. CPC B61D 15/06

(57) ABSTRACT

A train having a protection device with self-adaptive crashworthiness is disclosed, which relates to the technical field of safety protection of trains. The train includes multiple vehicles, a head vehicle is located at the head end of the train, and a head vehicle energy absorbing coupler mechanism is mounted at the front end of the head vehicle, each two adjacent vehicles are connected to each other by a middle vehicle energy absorbing coupler mechanism. An image acquisition mechanism and a radar detector are mounted at the head vehicle for monitoring whether there is an obstacle ahead the train, measuring distance and collision speed between the train and the obstacle, and for transmitting measured data to a processing center of the train, the processing center optimizes and adjusts impact force at the head vehicle energy absorbing coupler mechanism and the middle vehicle energy absorbing coupler mechanisms based on a collision situation.

### CROSS REFERENCE TO RELATED APPLICATION

This patent application claims the benefit and priority of Chinese Patent Application No. 202211036730.8, filed on Aug. 29, 2022, the disclosure of which is incorporated by reference herein in its entirety as part of the present application.

### TECHNICAL FIELD

The present disclosure relates to the technical field of safety protection of trains, and particularly relates to a train having a protection device with self-adaptive crashworthiness.

### BACKGROUND ART

In a conventional high-speed train, vehicles are connected to each other by tight lock couplers, and the tight lock couplers are main devices for transmitting force between the vehicles when the train collides. However, on the same high-speed train, the crushing displacement and the crushing force of the tight lock couplers at different positions are the same. As a result, when a train collides, a huge amount of kinetic energy will be preferentially absorbed by a vehicle close to the collision position, while a vehicle far away from the collision position can only absorb a small portion of the kinetic energy, resulting in that the vehicle close to the collision position is severely damaged, but the vehicle far away from the collision position is slightly damaged. At the same time, the existing main energy absorbing structure and the crushing force between the couplers are both designed in a collision standard of 36 km/h, and the occurrence of a collision accident of a train is very fortuitous, when the collision speed of the train occurs at different speeds, the energy absorbing structure cannot maximize the energy dissipation capacity.

### SUMMARY

The object of the present disclosure is to provide a train having a protection device with self-adaptive crashworthiness, so as to solve the problem existing in the prior art described above. The impact energy can uniformly be distributed to each vehicle when a collision occurs, thereby realizing a self-adaptive crashworthiness function thereof, and improving the overall level of crashworthiness.

To achieve the object described above, the present disclosure provides the following solutions:

The present disclosure provides a train having a protection device with self-adaptive crashworthiness, comprising a train composed of multiple vehicles, a head vehicle is located at a head end of the train, and a head vehicle energy absorbing coupler mechanism is mounted at a front end of the head vehicle, each two adjacent vehicles are connected to each other by a middle vehicle energy absorbing coupler mechanism, an image acquisition mechanism and a radar detector are mounted at the head vehicle, wherein the image acquisition mechanism and the radar detector are configured for monitoring whether there is an obstacle ahead the train, and for measuring distance and collision speed between the train and the obstacle, and for transmitting measured data to a processing center of the train, the processing center optimizes and adjusts impact force at the head vehicle energy absorbing coupler mechanism and the middle vehicle energy absorbing coupler mechanisms based on a collision situation.

Preferably, the head vehicle energy absorbing coupler mechanism and the middle vehicle energy absorbing coupler mechanisms each comprise an energy absorbing mechanism. The energy absorbing mechanism includes an energy absorbing shell, a collision rod, a first stopper, a second stopper, and an electromagnet. One end of the collision rod is extended into the energy absorbing shell and is fixed to the first stopper, and one end of the energy absorbing shell away from the collision rod is configured to be fixed to the vehicle, the second stopper is located in the energy absorbing shell, and the first stopper and the second stopper are arranged along an axial direction of the energy absorbing shell, outer walls of the first stopper and the second stopper are both in close contact with an inner wall of the energy absorbing shell, a magnetic fluid is filled between the first stopper and the second stopper, and the electromagnet is located in the magnetic fluid, and configured for adjusting viscosity of the magnetic fluid. In the head vehicle energy absorbing coupler mechanism, one end of the collision rod away from the first stopper is a free end, and in the middle vehicle energy absorbing coupler mechanism, one end of the collision rod away from the first stopper is configured for being fixed to another vehicle.

Preferably, the energy absorbing shell comprises a middle cylinder and two end covers, wherein both ends of the middle cylinder are opened and respectively closed by one of the end covers, and the end covers are detachably connected to the middle cylinder.

Preferably, limiting grooves are provided on the outer wall of the first stopper, and the first stopper is limited by shear bolts passing through a side wall of the energy absorbing shell and extending into the limiting grooves. When the train collides, the collision rod can drive the first stopper to move in a direction close to the second stopper to cut off the shear bolts, thereby realizing absorption of impact energy.

Preferably, two annular walls are fixed on the inner wall of the energy absorbing shell, an annular groove is formed between the two annular walls, and the electromagnet is mounted in the annular groove.

Preferably, a spring is further disposed in the energy absorbing shell, one end of the spring is fixed to one end of the second stopper away from the first stopper, and another end of the spring is fixed to an inner end face of one side of the energy absorbing shell away from the collision rod.

Preferably, the image acquisition mechanism is mounted at a windshield of the head vehicle.

Preferably, the radar detector is mounted on a front tip of the head vehicle.

Preferably, the image acquisition mechanism is a vision camera.

Preferably, the radar detector is a millimeter wave radar.

The present disclosure achieves the following technical effects with respect to the prior art:

The present embodiment provides a train having a protection device with self-adaptive crashworthiness, each two adjacent vehicles 2 are connected to each other by the middle vehicle energy absorbing coupler mechanism, the head vehicle is located at the head end of the vehicles, and the head vehicle energy absorbing coupler mechanism is mounted at the front end of the head vehicle, the image acquisition mechanism and the radar detector are mounted at the head vehicle, wherein image acquisition mechanism and radar detector are configured for monitoring whether there is an obstacle ahead the train, and for measuring the distance between the train and the obstacle and the collision speed, and for transmitting the measured data to the processing center of the train, the processing center calculates an optimal impact force based on current speed of the train and mass of each vehicle, and adjusts the impact force at the head vehicle energy absorbing coupler mechanism and each middle vehicle energy absorbing coupler mechanism, so that the head vehicle energy absorbing coupler mechanism and different middle vehicle energy absorbing coupler mechanisms have different energy absorbing effects, so as to ensure that the energy can be uniformly absorbed by all vehicles to the greatest extent when a collision occurs, avoiding the energy from being absorbed only by the head vehicle energy absorbing coupler mechanism located ahead the collision location, thereby the overall crashworthiness is improved, the impact energy is uniformly dispersed to the head vehicle energy absorbing coupler mechanism and each middle vehicle energy absorbing coupler mechanism, the self-adaptive crashworthiness function is realized, and the overall level of crashworthiness level is greatly improved.

### BRIEF DESCRIPTION OF THE DRAWINGS

To describe the technical solutions in the embodiments of the present disclosure or in the prior art more clearly, the following will briefly introduce the accompanying drawings required for describing the embodiments. Apparently, the accompanying drawings in the following description show only some embodiments of the present disclosure, and a person of ordinary skill in the art may still derive other accompanying drawings from these accompanying drawings without creative efforts.

FIG. 1 is a structural schematic view of a train having a protection device with self-adaptive crashworthiness provided by the present disclosure;

FIG. 2 is an enlarged schematic view of part A in FIG. 1;

FIG. 3 is an enlarged schematic view of part B in FIG. 1;

FIG. 4 is a left side view of FIG. 1;

FIG. 5 is a schematic structural view of an energy absorbing coupler mechanism of a head vehicle in the present disclosure;

FIG. 6 is a structural schematic view of an energy absorbing coupler mechanism of a middle vehicle in the present disclosure;

FIG. 7 is a schematic view of the internal structure of an energy absorbing mechanism in the present disclosure;

In the drawings: 100-train having a protection device with self-adaptive crashworthiness, 1-head vehicle, 2-vehicle, 3-head vehicle energy absorbing coupler mechanism, 4-middle vehicle energy absorbing coupler mechanism, 5-image acquisition mechanism, 6-radar detector, 7-energy absorbing mechanism, 701-collision rod, 702-energy absorbing shell, 703-first stopper, 704-magnetic fluid, 705-annular wall, 706-electromagnet, 707-second stopper, 708-spring, 709-middle cylinder, 710-shear bolt, 711-end cover.

### DETAILED DESCRIPTION OF THE EMBODIMENTS

The following will clearly and completely describe the technical solutions in the embodiments of the present disclosure with reference to the accompanying drawings in the embodiments of the present disclosure. Apparently, the described embodiments are merely a part rather than all of the embodiments of the present disclosure. All other embodiments derived by persons of ordinary skill in the art based on the embodiments of the present disclosure without creative efforts shall belong to the scope of the present disclosure.

The object of the present disclosure is to provide a train having a protection device with self-adaptive crashworthiness, so as to solve the technical problem of serious collision loss caused by the fact that the existing train cannot uniformly disperse impact energy to each vehicle when a collision occurs.

To make the object, features, and advantages of the present disclosure clearer and more comprehensible, the following further describes the present disclosure in detail with reference to the accompanying drawings and specific implementations.

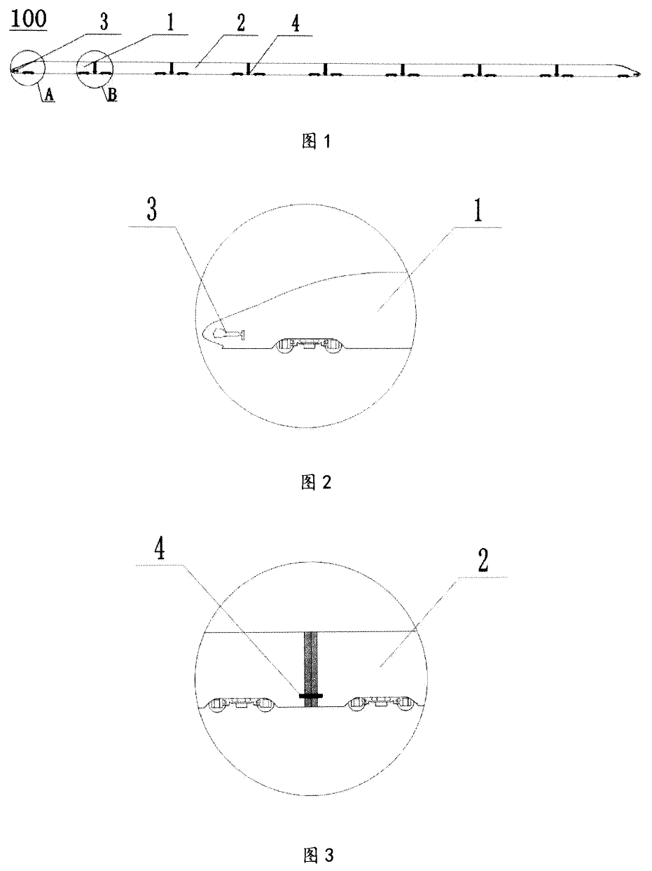

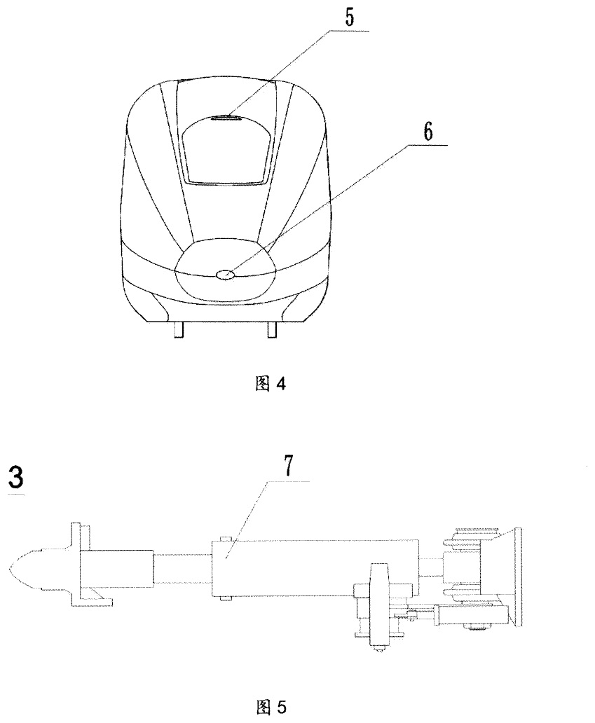

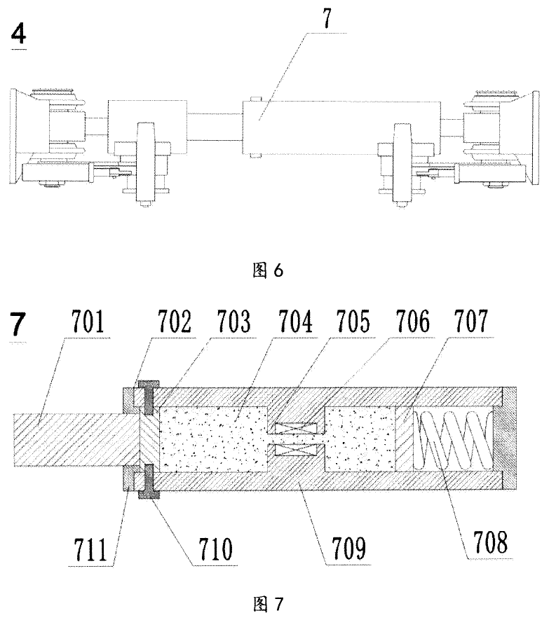

As shown in FIGS. 1-7, the present embodiment provides a train 100 having a protection device with self-adaptive crashworthiness, including a train composed of multiple vehicles 2, each two adjacent vehicles 2 are connected to each other by a middle vehicle energy absorbing coupler mechanism 4, a head vehicle 1 is located at a head end of the vehicles 2, and a head vehicle energy absorbing coupler mechanism 3 is mounted at a front end of the head vehicle 1, an image acquisition mechanism 5 and a radar detector 6 are mounted at the head vehicle 1, wherein the image acquisition mechanism and the radar detector are configured for monitoring whether there is an obstacle ahead the train, and for measuring the distance and the collision speed between the train and the obstacle, and for transmitting the measured data to a processing center of the train, the processing center calculates an optimal impact force based on the current speed of the train and mass of each vehicle 2, and adjusts the impact force at the head vehicle energy absorbing coupler mechanism 3 and each middle vehicle energy absorbing coupler mechanism 4, so that the head vehicle energy absorbing coupler mechanism 3 and each middle vehicle energy absorbing coupler mechanism 4 can have different energy absorbing effects, so as to ensure that the energy can be uniformly absorbed by the head vehicle energy absorbing coupler mechanism 3 and all middle vehicle energy absorbing coupler mechanisms 4 to the greatest extent when a collision occurs, avoiding the energy from being absorbed only by the head vehicle energy absorbing coupler mechanism 3, thereby the overall crashworthiness is improved, the impact energy is uniformly dispersed to the head vehicle energy absorbing coupler mechanism 3 and each middle vehicle energy absorbing coupler mechanism 4, the self-adaptive crashworthiness function is realized, and the overall level of crashworthiness level is greatly improved.

Specifically, as shown in FIG. 7, the head vehicle energy absorbing coupler mechanism 3 and the middle vehicle energy absorbing coupler mechanism 4 each comprise an energy absorbing mechanism 7. The energy absorbing mechanism 7 includes an energy absorbing shell 702, a collision rod 701, a first stopper 703, a second stopper 707, and an electromagnet 706. One end of the collision rod 701 is extended into the energy absorbing shell 702 and is fixed to the first stopper 703, and one end of the energy absorbing shell 702 away from the collision rod 701 is configured to be fixed to another vehicle 2, the second stopper 707 is located in the energy absorbing shell 702, and the first stopper 703 and the second stopper 707 are arranged along the axial direction of the energy absorbing shell 702, outer walls of the first stopper 703 and the second stopper 707 are both in close contact with an inner wall of the energy absorbing shell 702, so that an enclosed chamber is formed between the first stopper 703, the second stopper 707, and the inner wall of the energy absorbing shell 702, a magnetic fluid 704 is filled between the first stopper 703 and the second stopper 707, and the magnetic fluid 704 exhibits a property of low viscosity characteristic in zero magnetic field conditions, and a liquid property of high viscosity and low flow ability in the action of a strong magnetic field, and since the viscosity of the magnetic fluid 704 can be changed with the change of the strength of an applied magnetic field, the purpose of controlling the impact force is achieved by changing the current applied to the electromagnet 706 arranged in the magnetic fluid 704 to change the viscosity of the magnetic fluid 704. In the head vehicle energy absorbing coupler mechanism 3, one end of the collision rod 701 away from the first stopper 703 is a free end. In the middle vehicle energy absorbing coupler mechanism 4, one end of the collision rod 701 away from the first stopper 703 is configured for being fixed to another vehicle, so the impact force between two adjacent vehicles 2 is adjusted by the energy absorbing mechanism 7 while the two adjacent vehicles 2 are connected. The internal structure of the head vehicle energy absorbing coupler mechanism 3 is the same as the internal structure of the middle vehicle energy absorbing coupler mechanism 4 (namely, the energy absorbing mechanism 7), and the difference therebetween merely lies in that the external structure is different, and the external structure is consistent with the existing tight lock coupler, which will not be described herein again.

The energy absorbing shell 702 comprises a middle cylinder 709 and two end covers 711. Both ends of the middle cylinder 709 are opened and respectively closed by one of the end covers 711, and the end covers 711 can be detachably connected to the middle cylinder 709, thereby facilitating installation and replacement, so as to facilitate reuse.

Two annular walls 705 are fixed on the inner wall of the energy absorbing shell 702, an annular groove is formed between the two annular walls 705, and the electromagnet is mounted in the annular groove, thereby fixing the electromagnet 706 and ensuring stable operation thereof.

A spring 708 is further disposed in the energy absorbing shell 702, one end of the spring 708 is fixed to one end of the second stopper 707 away from the first stopper 703, and the other end of the spring 708 is fixed to an inner end surface of one side of the energy absorbing shell 702 away from the collision rod 701. When the train collides, the collision rod 701 is impacted, and pushes the first stopper 703 and the magnetic fluid 704 to move towards the direction close to the other vehicle 2, the magnetic fluid 704 pushes the second stopper 707 to move towards the right, and compresses the spring 708.

Limiting grooves are provided on the outer wall of the first stopper 703, and the first stopper 703 is limited by shear bolts 710 passing through a side wall of the energy absorbing shell 702(namely, side walls of the middle cylinder 709) and extending into the limiting grooves, so as to limit the first stopper 703. When a train collides, the collision rod 701 can drive the first stopper 703 to move in a direction close to the second stopper 707 to cut off the shear bolts 710, thereby realizing collision energy absorbing. When the train drives normally, the shear bolts 710 mechanically lock the energy absorbing mechanism 7, and there is no relative movement between the head and the tail seat of a coupler; when the train collides, the collision rod 701 disables the shear bolts 710 under the impact force, and pushes the magnetic fluid 704 in the closed chamber to flow in a direction close to the spring 708, and then pushes the second stopper 707 to move right and compress the spring 708, thereby realizing collision energy absorbing. After the collision energy absorbing is completed, the impact force of the couplers is reduced to zero, the first stopper 703, the magnetic fluid 704, and the second stopper 707 are moved to the initial position under the elastic recovery force of the spring 708, and the energy absorbing mechanism 7 can be reused by adding shear bolts 710.

The image acquisition mechanism 5 is mounted at the windshield of the head vehicle 1, and the image acquisition mechanism 5 is a vision camera. The radar detector 6 is mounted on the front tip of the head vehicle 1, and the radar detector 6 is a millimeter wave radar.

The principle and implementations of the present disclosure are described in the description by using specific embodiments, and the description of the foregoing embodiments is only intended to help understand the method and core idea of the present disclosure; In addition, persons of ordinary skill in the art may make modifications to the specific implementations and application range based on the ideas of the present disclosure. In conclusion, the content of the description shall not be understood as a limitation on the present disclosure.

What is claimed is:

1. A train having a protection device with self-adaptive crashworthiness, comprising a train composed of multiple vehicles, a head vehicle is located at a head end of the train, and a head vehicle energy absorbing coupler mechanism is mounted at a front end of the head vehicle, each two adjacent vehicles are connected to each other by a middle vehicle energy absorbing coupler mechanism, an image acquisition mechanism and a radar detector are mounted at the head vehicle, wherein the image acquisition mechanism and the radar detector are configured for monitoring whether there is an obstacle ahead the train, for measuring distance and collision speed between the train and the obstacle, and for transmitting measured data to a processing center of the train, the processing center optimizes and adjusts impact force at the head vehicle energy absorbing coupler mechanism and the middle vehicle energy absorbing coupler mechanisms based on a collision situation.

2. The train having a protection device with self-adaptive crashworthiness according to claim 1, wherein the head vehicle energy absorbing coupler mechanism and the middle vehicle energy absorbing coupler mechanisms each comprise an energy absorbing mechanism, the energy absorbing mechanism includes an energy absorbing shell, a collision rod, a first stopper, a second stopper, and an electromagnet, one end of the collision rod is extended into the energy absorbing shell and is fixed to the first stopper, and one end of the energy absorbing shell away from the collision rod is configured to be fixed to the vehicle, the second stopper is located in the energy absorbing shell, and the first stopper and the second stopper are arranged along a axial direction of the energy absorbing shell, outer walls of the first stopper and the second stopper are both in close contact with an inner wall of the energy absorbing shell, a magnetic fluid is filled between the first stopper and the second stopper, and the electromagnet is located in the magnetic fluid, and configured for adjusting viscosity of the magnetic fluid; in the head vehicle energy absorbing coupler mechanism, one end of the collision rod away from the first stopper is a free end, and in the middle vehicle energy absorbing coupler mechanism, one end of the collision rod away from the first stopper is configured for being fixed to another vehicle.

3. The train having a protection device with self-adaptive crashworthiness according to claim 2, wherein the energy absorbing shell comprises a middle cylinder and two end covers, both ends of the middle cylinder are opened and respectively closed by one of the end covers, and the end covers are detachably connected to the middle cylinder.

4. The train having a protection device with self-adaptive crashworthiness according to claim 2, wherein limiting grooves are provided on the outer wall of the first stopper, and the first stopper is limited by shear bolts passing through a side wall of the energy absorbing shell and extending into the limiting grooves, when the train collides, the collision rod is able to drive the first stopper to move in a direction close to the second stopper to cut off the shear bolts, thereby realizing absorption of impact energy.

5. The train having a protection device with self-adaptive crashworthiness according to claim 2, wherein two annular walls are fixed on the inner wall of the energy absorbing shell, an annular groove is formed between the two annular walls, and the electromagnet is mounted in the annular groove.

6. The train having a protection device with self-adaptive crashworthiness according to claim 2, wherein a spring is further disposed in the energy absorbing shell, one end of the spring is fixed to one end of the second stopper away from the first stopper, and another end of the spring is fixed to an inner end face of one side of the energy absorbing shell away from the collision rod.

7. The train having a protection device with self-adaptive crashworthiness according to claim 1, wherein the image acquisition mechanism is mounted at a windshield of the head vehicle.

8. The train having a protection device with self-adaptive crashworthiness according to claim 1, wherein the radar detector is mounted on a front tip of the head vehicle.

9. The train having a protection device with self-adaptive crashworthiness according to claim 1, wherein the image acquisition mechanism is a vision camera.

10. The train having a protection device with self-adaptive crashworthiness according to claim 1, wherein the radar detector is a millimeter wave radar.
